(19) United States
(12) Patent Application Publication
(10) Pub. No.: US 2004/0194320 A1
(43) Pub. Date: Oct. 7, 2004

(54) Apparatus for pruning high branches

(76) Inventor: Jung-Te Hsieh, Chang Hua Hsien (TW)

Correspondence Address: BIRCH STEWART KOLASCH & BIRCH, PO BOX 747, FALLS CHURCH, VA, 22040-0747, US

(21) Appl. No.: 10/404,428

(22) Filed: Apr. 2, 2003

(51) Int. Cl. B26B 13/00

(52) U.S. Cl. 30/250

(57) ABSTRACT

A pruning apparatus includes a handle, a trigger, a support, a chopping block, a pivotal blade and a transmission. The trigger is movably mounted on the handle. The support is connected with the handle. The chopping block is connected with the support. The pivotal blade is pivotally connected with the support or the chopping block. The transmission is arranged between the trigger and the pivotal blade for transforming linear movement of the trigger to pivotal of the pivotal blade. In another aspect, a pruning apparatus includes a handle, a trigger, a support, a stationary blade, a pivotal blade and a transmission. The trigger is movably mounted on the handle. The support is connected with the handle. The stationary blade is connected with the support. The pivotal blade is pivotally connected with the support or the stationary blade. The transmission is arranged between the trigger and the pivotal blade for transforming linear movement of the trigger to pivotal of the pivotal blade.

### BACKGROUND OF INVENTION

1. Field of Invention

The present invention relates to an apparatus for pruning high branches.

2. Related Prior Art

Taiwanese Patent Publication No. 237601 discloses a conventional apparatus for pruning high branches. This conventional apparatus includes a pole 30, a cap 40 mounted on the pole 30, a blade 21 partially fit in the cap 40, a blade 22 pivotally connected with the blade 21, a lever 29 pivotally connected with the blade 22 and a lever 25 pivotally connected with the blade 21 and with the lever 29. A cable 50 is tied to two ears 252 pivotally connected with the lever 25. The cable 50 is wound about a pulley 49 mounted on two ears 48 formed on the cap 40 and a pulley 52 mounted on the ears 251. The cable 50 can be pulled so as to pivot the lever 25 toward the blade 21, thus pivoting the blade 22 toward the blade 21 for shearing. Transmission through the cable 50 is however not reliable. This conventional apparatus is structurally complicated for including quite a few elements.

The present invention is therefore intended to obviate or at least alleviate the problems encountered in prior art.

### SUMMARY OF THE INVENTION

It is an objective of the present invention to provide a reliable apparatus for pruning high branches.

It is another objective of the present invention to provide a structurally simple apparatus for pruning high branches.

According to the present invention, a pruning apparatus includes a handle, a trigger, a support, a chopping block, a pivotal blade and a transmission. The trigger is movably mounted on the handle. The support is connected with the handle. The chopping block is connected with the support. The pivotal blade is pivotally connected with the support or the chopping block. The transmission is arranged between the trigger and the pivotal blade for transforming linear movement of the trigger to pivotal of the pivotal blade.

In another aspect, a pruning apparatus includes a handle, a trigger, a support, a stationary blade, a pivotal blade and a transmission. The trigger is movably mounted on the handle. The support is connected with the handle. The stationary blade is connected with the support. The pivotal blade is pivotally connected with the support or the stationary blade. The transmission is arranged between the trigger and the pivotal blade for transforming linear movement of the trigger to pivotal of the pivotal blade.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings wherein:

FIG. 1 is a perspective view of an apparatus for pruning high branches according to a first embodiment of the present invention.

FIG. 2 is an exploded view of the pruning apparatus shown in FIG. 1.

FIG. 3 is a cross-sectional view of the pruning apparatus shown in FIG. 1.

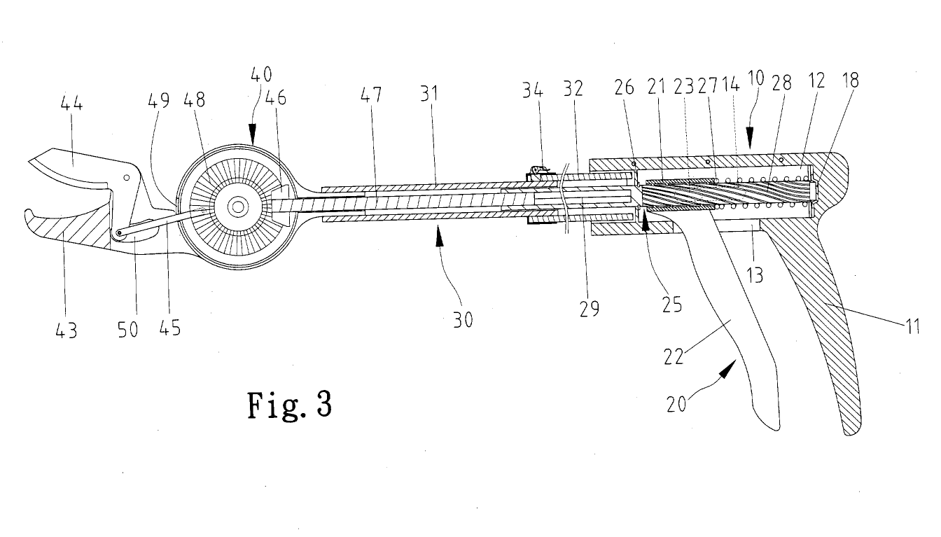

FIG. 4 is similar to FIG. 3 but showing the pruning apparatus in a different position.

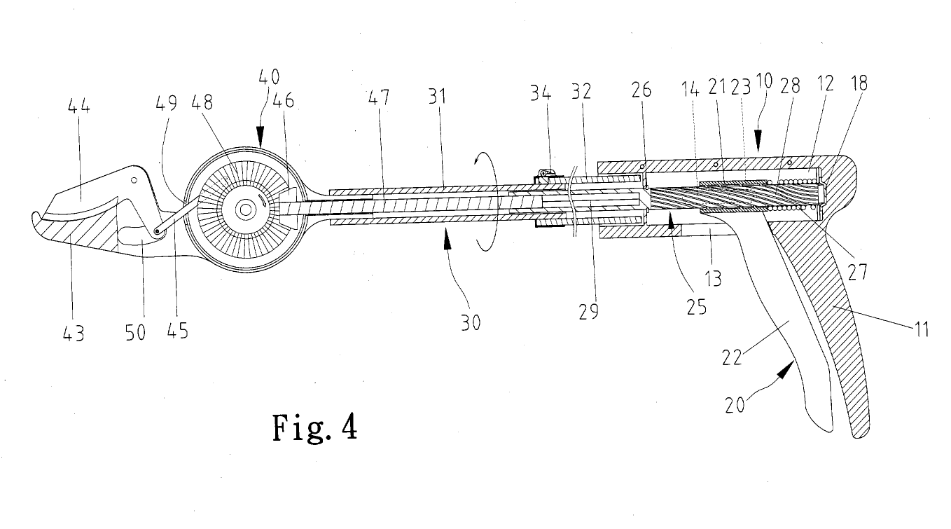

FIG. 5 is a perspective view of an apparatus for pruning high branches according to a second embodiment of the present invention.

### DETAILED DESCRIPTION OF PREFERRED EMBODIMENT

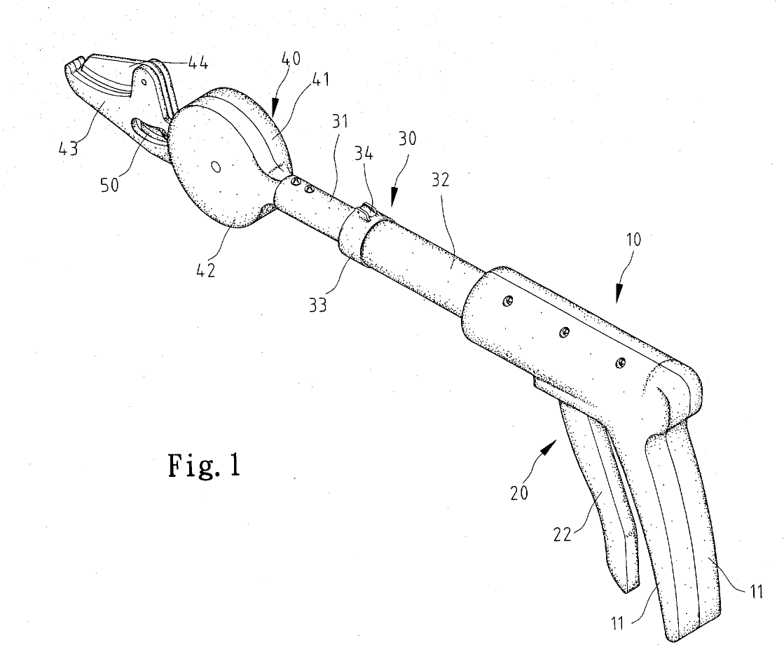

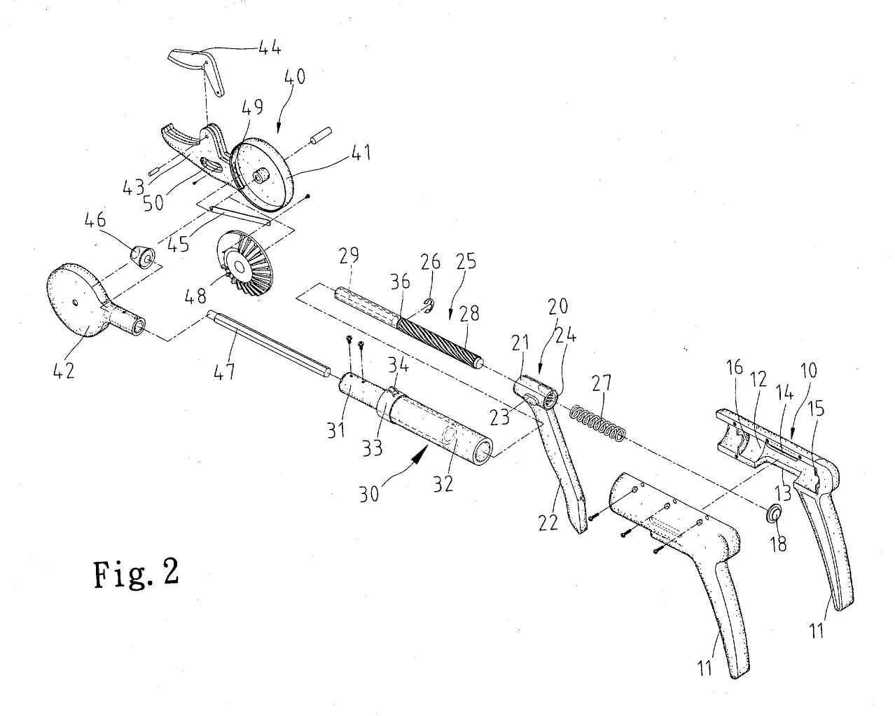

Referring to FIGS. 1 and 2, according to the preferred embodiment of the present invention, an apparatus for pruning high branches includes a handle 10, a trigger 20, a support, a transmission, a chopping block 43 and a blade 44.

Referring to FIG. 2, the handle 10 is assembled from two halves (not numbered). The handle 10 includes a grip 11 and a tubular portion 12 extending from the grip 11. The tubular portion 12 of the handle 10 includes a closed end and an open end. A recess 15 is defined in an internal face of the tubular portion 12 at the closed end.

An annular stop 16 is formed on the internal face of the tubular portion 12 near the open end. A slot 13 longitudinally extends in the tubular portion 12 of the handle 10, and so do two slots 14.

The trigger 20 includes a tubular portion 21 and a linear portion 22 extending from the tubular portion 21. The tubular portion 21 of the trigger 20 is movably inserted in the tubular portion 12 of the handle 10, and the linear portion 22 of the trigger 20 is inserted through the slot 13. Two ribs 23 extend on an external face of the tubular portion 21 of the trigger 20. The ribs 23 are inserted in the slots 14, thus ensuring smooth movement of the trigger 20 relative to the handle 10. A spring 27 is inserted in the tubular portion 12. The spring 27 is compressed between the closed end of the tubular portion 12 and the tubular portion 21 of the trigger 20. On an internal face of the tubular portion 21 of the trigger 20 extend some threads 24 like rifling.

The support includes a telescopic structure 30 and a housing 40.

The telescopic structure 30 includes a internal tube 31 and a external tube 32. The internal tube 31 is telescopically inserted in the external tube 32. The external tube 32 is fit in the tubular portion of the handle 10. A fastener is used to hold the internal tube 31 in position relative to the external tube 32. The fastener includes two ears 33 formed on the external tube 32 and a cam 34 mounted on the ears 33 for engagement with the internal tube 31. The external tube 32 is inserted into the tubular portion 12 of the handle 10.

The housing 40 is used to house the other elements of the transmission and support the chopping block 43 and the blade 44. The housing 40 includes a first half 42 secured to the internal tube 31 and a second half 41 secured to the first half 42. The chopping block 43 is laminate element made of two lateral plates and a middle plate. The lateral plates of the chopping block 43 are identical to each other. Each of the lateral plates of the chopping block 43 includes a first section extending from the second half 41 of the housing 40, a second section extending longitudinally from the first section and a third section extending transversely from the first section. The middle plate of the chopping block 43 is shaped corresponding to and sandwiched between the second sections of the lateral plates of the chopping block 43. The blade 44 is located between and mounted on the third portions of the plates of the chopping block 43. The blade 44 can be pivoted between the third portions of the plates of the chopping block 43 and between the first portions of the plates of the chopping block 43.

The transmission includes a first axle 25, a second axle 27, a first bevel gear 46, a second bevel gear 48 and a lever 45.

The first axle 25 includes threads 28 extending on a first section and a non-circular recess 29 extending in a second section. The first section of the first axle 25 is inserted into the tubular portion 21 of the trigger 20. The threads 28 engage with the threads 24 so that movement of the trigger 20 causes rotation of the first axle 25. A C-ring 26 is fit in an annular groove 36 extending about the first axle 25, between the first and second sections. The C-ring 26 is shrunk before it is moved past the annular stop 16. After the C-ring 26 is moved past the annular stop 16, it is released and return to its original size for abutment against the annular stop 16, thus retaining the first section of the first axle 25 in the tubular portion 12.

Before the first axle 25 is inserted in the tubular portion 12, a cap 18 is put in the recess 15 so as to receive the first axle 25. The cap 18 is made of metal in order to protect the tubular portion 12 made of plastic from wearing that would otherwise occur due to contact with the first axle 25.

The second axle 47 includes a non-circular profile for movable and non-rotational insertion in the non-circular recess 29. Thus, rotation of the first axle 25 causes rotation of the second axle 47.

The first bevel gear 46 is secured to the second axle 47. A second bevel gear 48 is rotationally mounted on the second shell 41. The first bevel gear 46 is engaged with the second bevel gear 48. Thus, rotation of the first bevel gear 46 causes rotation of the second bevel gear 48. The lever 45 extends through a slot 49 defined in the second half 41 of the housing 40. The lever 45 includes a first end rotationally connected with the second bevel gear 48 and a second end rotationally connected with the blade 44. Rotation of the second bevel gear 48 causes pivotal of the blade 44. Each of lateral plates of the chopping block 43 defines a slot 50 through which a pin (not numbered) is fit into a hole (not numbered) defined in the blade 44 and a hole (not numbered) defined in a second end of the lever 45.

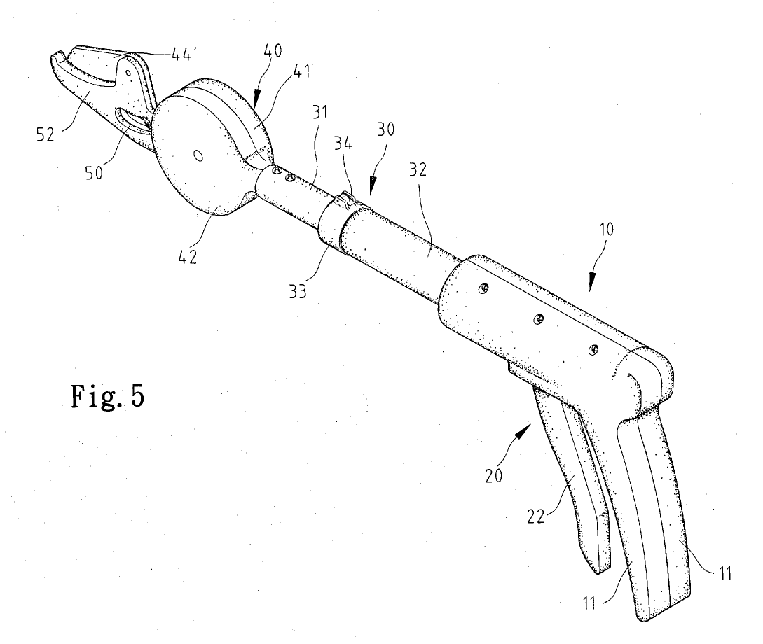

FIG. 5 shows a pruning apparatus according to a second embodiment of the present invention. The second embodiment is identical to the first embodiment except for including a stationary blade 52 instead of the chopping board 43.

The present invention has been described through detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is

1. A pruning apparatus including:
a handle;
a trigger movably mounted on the handle;
a support connected with the handle;
a chopping block connected with the support;
a pivotal blade mounted on one of the support and the chopping block; and
a transmission arranged between the trigger and the pivotal blade for transforming linear movement of the trigger to pivotal of the pivotal blade.

2. The pruning apparatus according to claim 1 wherein the pivotal blade is mounted on the chopping block.

3. The pruning apparatus according to claim 1 wherein the support includes:
a tubular structure connected with the handle; and
a housing arranged between the tubular structure and the chopping block.

4. The pruning apparatus according to claim 3 wherein the transmission includes:
an axle inserted in the handle and the tubular structure and connected with the trigger; and
a gear installed in the housing and connected with the pivotal blade.

5. The pruning apparatus according to claim 4 wherein the trigger includes threads, and the axle includes threads engaged with the threads of the trigger.

6. The pruning apparatus according to claim 5 wherein the trigger includes a tubular portion with an external face on which the threads extend.

7. The pruning apparatus according to claim 4 wherein the tubular structure includes a first tube and a second tube telescopically connected with the first tube, and the axle includes a first axle and a second axle telescopically and non-rotationally connected with the first axle.

8. The pruning apparatus according to claim 7 wherein the tubular structure includes a fastener for holding the second tube in position relative to the first tube.

9. The pruning apparatus according to claim 8 wherein the fastener includes two ears formed on the first tube and a cam mounted on the ears for engagement with the second tube.

10. The pruning apparatus according to claim 7 wherein the first axle defines a non-circular recess, and the second axle includes a non-circular profile inserted in the non-circular recess.

11. The pruning apparatus according to claim 4 wherein the gear includes a first bevel gear connected with the axle and a second bevel gear arranged with the first bevel gear and connected with the pivotal blade.

12. The pruning apparatus according to claim 11 wherein the gear includes a lever with arranged between the first bevel gear and the pivotal blade.

13. The pruning apparatus according to claim 12 wherein the housing defines a slot through which the lever extends.

14. The pruning apparatus according to claim 3 wherein the housing includes a first half and a second half.

15. The pruning apparatus according to claim 1 wherein the handle includes a tubular portion, and the trigger includes an end arranged in the tubular portion of the handle.

16. The pruning apparatus according to claim 15 including a spring compressed between a closed end of the tubular portion of the handle and the end of the trigger.

17. The pruning apparatus according to claim 16 wherein the end of the trigger includes a rib formed thereon, and the tubular portion of the handle defines a slot for receiving the rib.

18. A pruning apparatus including:
a handle;
a trigger movably mounted on the handle;
a support connected with the handle;
a stationary blade connected with the support;
a pivotal blade connected with one of the support and the stationary blade; and
a transmission arranged between the trigger and the pivotal blade for transforming linear movement of the trigger to pivotal of the pivotal blade.

19. The pruning apparatus according to claim 18 wherein the pivotal blade is connected with the stationary blade.

20. The pruning apparatus according to claim 19 wherein the stationary blade defines a slot for receiving a fastener for connecting the pivotal blade with the lever.
